(19) United States
(12) Patent Application Publication
(10) Pub. No.: US 2022/0095723 A1
(43) Pub. Date: Mar. 31, 2022

(54) COMPOSITE GARMENT COMPRISING MOISTURE-WICKING, SCENT- CONTROLLED, ANTI-MICROBIAL FABRIC AND METHOD TO MANUFACTURE SAME

(71) Applicant: Focus Stream International, LLC, Dover, DE (US)

(72) Inventor: James Kelly Crum, Lakeland, TN (US)

(21) Appl. No.: 17/490,434

(22) Filed: Sep. 30, 2021

Related U.S. Application Data
(60) Provisional application No. 63/085,498, filed on Sep. 30, 2020.

(51) Int. Cl. A41D 31/30; A41D 1/22; A41D 31/10

(52) U.S. Cl. CPC A41D 31/305; A41D 31/10; A41D 1/22

(57) ABSTRACT

An anti-wicking, scent-controlled, anti-microbial fabric is disclosed. Such anti-wicking, scent-controlled, anti-microbial fabric may be used to manufacture special occasion dresses, including wedding dresses and bridesmaid dresses. Also disclosed is a method of making a garment comprising an inner layer and an outer layer, using the anti-wicking, scent-controlled, anti-microbial fabric of the present invention.

### CROSS REFERENCE TO RELATED APPLICATIONS

The present invention derives priority from U.S. Provisional Patent Application No. 63/085,498, filed Sep. 30, 2020, the entirety of which is incorporated herein by reference.

### BACKGROUND OF THE INVENTION

### Field of the Invention

The following disclosure relates generally to a new and useful improvement in formal wear apparel. More particularly, the disclosure relates to an anti-wicking, scent-controlled, anti-microbial fabric used to manufacture special occasion dresses, including wedding dresses and bridesmaid dresses. The anti-wicking, scent-controlled, anti-microbial fabric may also be used to manufacture other formal wear garments for men including tuxedo pieces and suits.

### Description of the Background

Throughout history, women and men have worn formal wear or formal attire to special occasions such as weddings and other formal events. Formal wear for women may include wedding dresses, bridesmaid dresses and other formal evening dresses, while formal wear for men may include tuxedo pieces and suits. Formal wear, particularly wedding dresses and bridesmaid dresses, is commonly manufactured using fabrics such as satin, charmeuse, chiffon, organza, tulle, lace and combinations thereof. These fabrics work alone or in combination to provide the unique designs implemented in such dresses as well as the contour desired by the wearer.

Satin is the most common fabric used to manufacture such formal dresses because satin material is durable and versatile. Satin is not a fiber used to make a fabric. Instead, satin is a finish on a fiber consisting of pure silk, all polyester or blend thereof. Such polyester and silk fabrics are thick, heavy fabrics. Thus, it is well known within the formal wear industry that traditional formal wear being manufactured with such thick, heavy fabrics leads the wearer to perspire causing the wearer to become quite uncomfortable during a special event. Formal wear, such as a wedding dresses, bridesmaid dresses and tuxedos, having anti-wicking, anti-scent, and anti-microbial properties is needed.

### BRIEF SUMMARY OF THE INVENTION

An anti-wicking, scent-controlled, anti-microbial fabric is disclosed. Such anti-wicking, scent-controlled, anti-microbial fabric may be used to manufacture special occasion dresses, including wedding dresses and bridesmaid dresses. The anti-wicking, scent-controlled, anti-microbial fabric may also be used to manufacture other formal wear garments for men including tuxedo pieces and suits. In one embodiment, the anti-wicking, scent-controlled, anti-microbial fabric may comprise polyester. In another embodiment, the fabric may comprise a blend of nylon and spandex. It is foreseeable that the anti-wicking, scent-controlled, anti-microbial fabric may comprise any fiber or combinations of fibers as desired by one of skill in the art.

In one embodiment, the fabric may comprise 100% polyester. The fabric construction with yarn type and yarn size is FDP75d/72f×FDP90d/96f, which is a woven construction. FDP represents full dull polyester. 75d represents 75 denier which is the size of the yarn in the warp/vertical; 72f represents 72 filaments which are combined to make the total yarn size. 90 denier represents the yarn size in the weft/fill. 96f represents 96 filaments which are combined to make the total yarn size. This is a microfiber yarn, which makes the overall fabric softener.

In another embodiment, the fabric may comprise 85% nylon and 15% spandex. The construction of the nylon/spandex blend is FDN70d/72f+40d Spandex. This is a knit construction. FDN represents full dull nylon. 70d/72f represents 70 denier yarn size by 72 filaments that are combined to make up the total yarn size. 40d Spandex represents the size of the spandex core of the yarn. Nylon fibers cover the spandex core to create the yarn used in this product.

In one embodiment, the fabric is treated with an anti-wicking finish. The anti-wicking finish or wicking Finish (WF) absorbs moisture away from the body and disperses the moisture throughout the surface of the fabric. This creates more comfort for the wearer as moisture does not saturate the fabric in one spot and stick to the body. When moisture is spread out, it does not feel as wet which enhances comfort.

In another embodiment, the fabric may also be treated with a scent control. The scent control is applied in a chemical bath. The scent control treatment is put in a bath and the fabric roll is run through the bath, absorbing the treatment. It is then run through a dryer which sets the treatment into the fabric.

In still a further embodiment, the fabric may be treated with an anti-microbial control. The anti-microbial control and inhibits the growth of bacteria that can collect on the fabric. Bacteria can grow from the perspiration that is collected on the fabric and can smell (think old, unwashed towel). This treatment prevents the smell that occurs with bacteria growth.

The moisture-wicking, scent-controlled, anti-microbial fabric may be used to manufacture formal wear, referred to herein as composite garments. In one embodiment, the composite garment comprises an outer layer of fabric attached to an inner liner of fabric. In one example embodiment, the inner liner of fabric is comprised of the moisture-wicking, scent-controlled, anti-microbial fabric. In one embodiment, the inner liner of fabric may include a bodice support which effectively supports and enhances the bust while supporting, smoothing and elongating the bodice of the dress.

The present invention also discloses a method to manufacture a composite garment, such as a wedding dress, bridesmaid dress or other formal dress. This method involves the steps of (1) obtaining an outer layer of fabric having a top edge, a fastenable opening, and a seam allowance; (2) obtaining an inner liner of fabric comprising a top edge and a bottom edge, a fastenable opening coexistent with the fastenable opening of the dress, wherein the inner liner of fabric comprises moisture-wicking, scent-controlled, anti-microbial fabric, wherein the inner liner comprises a bodice support having a plurality of stays which extend from substantially the top edge of the bodice support to the bottom edge of the bodice support and which are placed in close proximity to each other, and a seam allowance, wherein a slip is attached to the bottom edge of the bodice support; (3) altering the seam allowance in the outer layer of fabric to accommodate the wearer of the dress; (4) altering the seam allowance of the inner liner of fabric to accommodate the wearer of the liner; and (5) attaching the top edge of the outer layer of fabric to the top edge of the inner liner of fabric.

### DESCRIPTION OF THE DRAWINGS

FIG. 1 is a front perspective view of the composite garment.

FIG. 2 is a front perspective view of the composite garment with certain parts away to show details of the bodice support of the liner.

FIG. 3 is a rear elevational view of the composite garment showing the liner, the strapless bodice support and attached slip.

FIG. 4 is a rear elevational view of the composite garment showing the liner, the halter bodice support and attached slip.

### DETAILED DESCRIPTION OF THE INVENTION

In the following detailed description of the preferred embodiments, reference is made to the accompanying drawings which form a part hereof, and in which are shown by way of illustrating specific embodiments in which the invention may be practiced. It is understood that other embodiments may be utilized and structural changes may be made without departing from the scope of the present invention.

As used by Applicants in this application hereto:

(1) “attached to” refers to the joining of two pieces of material by sewing approximately one-fourth inch to five-eighths inch from the edge;

(2) “bodice” refers to the upper region of a woman's dress;

(3) “bodice support” refers to a woman's close-fitting supporting undergarment that is fastenable and which extends from above or beneath the bust to the waist or below the waist;

(4) “bottom edge” refers to the bottom surface line of the bodice support;

(5) “close proximity” refers to being near in space and relationship;

(6) “dart” refers to a stitched tapering fold in a garment;

(7) “dress” refers to a one-piece garment, which contains lining, for a woman or girl that covers the body and extends down over the legs usually consisting of a bodice and skirt;

(8) “interfacing” refers to fabric sewn between the facing and the outside of a garment for stiffening and shaping retention;

(9) “interlining” refers to a lining sewn between the ordinary lining and the outside fabric;

(10) “liner” refers to the combination of a bodice support and slip, which is attachable to a dress;

(11) “lining” refers to a material that is used to line the inner surface of a dress;

(12) “obtaining a dress” refers to manufacturing the dress oneself or coming into possession of a dress manufactured by another;

(13) “obtaining a liner” refers to manufacturing the liner oneself or coming into possession of the liner manufactured by another;

(14) “slip” refers to an underskirt which is usually a little shorter than outer clothing and often made with a ruffled, pleated, or lace edge;

(15) “stay” refers to a thin firm strip interlaced throughout the materials of a bodice support to provide support to the midriff, abdomen and bust;

(16) “top edge” refers to the top surface line of the dress or the bodice support;

(17) “top stitch” refers to making a line of stitching on the outside of the composite garment close to the seam;

(18) “underwire” refers to circular or semicircular wire support stitched around or under the bust cups;

(19) “zero centimeters” refers to stays placed side by side each other.

An anti-wicking, scent-controlled, anti-microbial fabric is disclosed. Such fabric may be used to manufacture special occasion dresses, including wedding dresses and bridesmaid dresses. The fabric may also be used to manufacture other formal wear garments for men including tuxedo pieces and suits. It is foreseeable that the anti-wicking, scent-controlled, anti-microbial fabric may be used to manufacture any particular piece of formal wear as desired by one of skill in the art. In particular, the anti-wicking, scent-controlled, anti-microbial fabric may be used to manufacture medical scrub and gowns.

In one embodiment, the anti-wicking, scent-controlled, anti-microbial fabric may comprise polyester. In another embodiment, the anti-wicking, scent-controlled, anti-microbial fabric may comprise a blend of nylon and spandex. It is foreseeable that the anti-wicking, scent-controlled, anti-microbial fabric may comprise any fiber or combinations of fibers as desired by one of skill in the art. In one example embodiment, the anti-wicking, scent-controlled, anti-microbial fabric may be dyed to match any desired color.

In one example embodiment, the fabric may comprise 100% polyester. The fabric construction with yarn type and yarn size is FDP75d/72f×FDP90d/96f, which is a woven construction. FDP represents full dull polyester. 75d represents 75 denier which is the size of the yarn in the warp/vertical; 72f represents 72 filaments which are combined to make the total yarn size. 90 denier represents the yarn size in the weft/fill. 96f represents 96 filaments which are combined to make the total yarn size. This is a microfiber yarn, which makes the overall fabric softener. Varying size denier fibers may be used as desired by one of skill in the art.

In another embodiment, the fabric may comprise 85% nylon and 15% spandex. The construction of the nylon/spandex blend is FDN70d/72f+40d Spandex. This is a knit construction. FDN represents full dull nylon. 70d/72f represents 70 denier yarn size by 72 filaments that are combined to make up the total yarn size. 40d Spandex represents the size of the spandex core of the yarn. Nylon fibers cover the spandex core to create the yarn used in this product. Varying size denier fibers may be used for construction as desired by one of skill in the art. In one embodiment, such fabric construction displays anti-snag properties.

In other embodiments, the fabric may comprise any blend of nylon, spandex, and polyester. Embodiments may include nylon and spandex blends comprising 95% nylon, or 90% nylon, or 80% nylon, or 75% nylon, or 70% nylon, or 65% nylon, or 60% nylon, or 55% nylon, or 50% nylon, or 45% nylon, or 40% nylon, or 35% nylon, or 30% nylon, or 25% nylon, or 20% nylon, or 15% nylon, or 10% nylon, or 5% nylon. In some embodiments, the fabric may comprise 100% nylon. In some embodiments, the fabric may comprise 100% spandex.

In one embodiment, the fabric is treated with an anti-wicking or moisture-wicking finish. The anti-wicking finish or wicking Finish (WF) absorbs moisture away from the body and disperses the moisture throughout the surface of the fabric. This creates more comfort for the wearer as moisture does not saturate the fabric in one spot and stick to the body. When moisture is spread out, it does not feel as wet which enhances comfort.

In another example embodiment, the fabric may also be treated with a scent-control treatment. The scent-control treatment is applied to the fabric fibers and such treatment encapsulates the fibers and absorbs any odor particles which make contact with the fibers of the fabric. The scent-control treatment prevents the fibers from absorbing the odor particles. When the fabric is cleaned or laundered, the scent-control treatment allows the odor particles to be released from the fabric. Any other scent-control treatment may be used as desired by one of skill in the art. The scent control is applied in a chemical bath. The scent control treatment is put in a bath and the fabric roll is run through the bath, absorbing the treatment. It is then run through a dryer which sets the treatment into the fabric.

In still a further example embodiment, the fabric may be treated with an anti-microbial control treatment. The anti-microbial control treatment prevents bacteria and other microbial growth, which may lead to odors as well as bacterial infections. In one embodiment, the anti-microbial control treatment may comprise all natural ingredients. In one embodiment, the anti-microbial control treatment may comprise zinc and may be free of heavy metals such as silver. Other anti-microbial control treatment compositions may be used as desired by one of skill in the art. The anti-microbial control and inhibits the growth of bacteria that can collect on the fabric. Bacteria can grow from the perspiration that is collected on the fabric and can smell (think old, unwashed towel). This treatment prevents the smell that occurs with bacteria growth.

In another example embodiment, the anti-wicking, scent-controlled, anti-microbial fabric may be treated with ultra-violet protection.

The moisture-wicking, scent-controlled, anti-microbial fabric may be used to manufacture formal wear, referred to herein as composite garments. In one embodiment, the composite garment comprises an outer layer of fabric attached to an inner liner of fabric. In one example embodiment, the inner liner of fabric is comprised of a moisture-wicking, scent-controlled, anti-microbial fabric. In one embodiment, the inner liner of fabric may include a bodice support which effectively supports and enhances the bust while supporting, smoothing and elongating the bodice of the dress.

The present invention also discloses a method to manufacture a composite garment, such as a wedding dress, bridesmaid dress or other formal dress. This method involves the steps of (1) obtaining an outer layer of fabric having a top edge, a fastenable opening, and a seam allowance; (2) obtaining an inner liner of fabric comprising a top edge and a bottom edge, a fastenable opening coexistent with the fastenable opening of the dress, wherein the inner liner comprises moisture-wicking, scent-controlled, anti-microbial fabric, wherein the inner liner may comprise a bodice support having a plurality of stays which extend from substantially the top edge of the bodice support to the bottom edge of the bodice support and which are placed in close proximity to each other, and a seam allowance, wherein a slip may be attached to the bottom edge of the bodice support; (3) altering the seam allowance in the outer layer of fabric to accommodate the wearer of the dress; (4) altering the seam allowance of the inner liner of fabric to accommodate the wearer of the liner; and (5) attaching the top edge of the outer layer of fabric to the top edge of the inner liner of fabric.

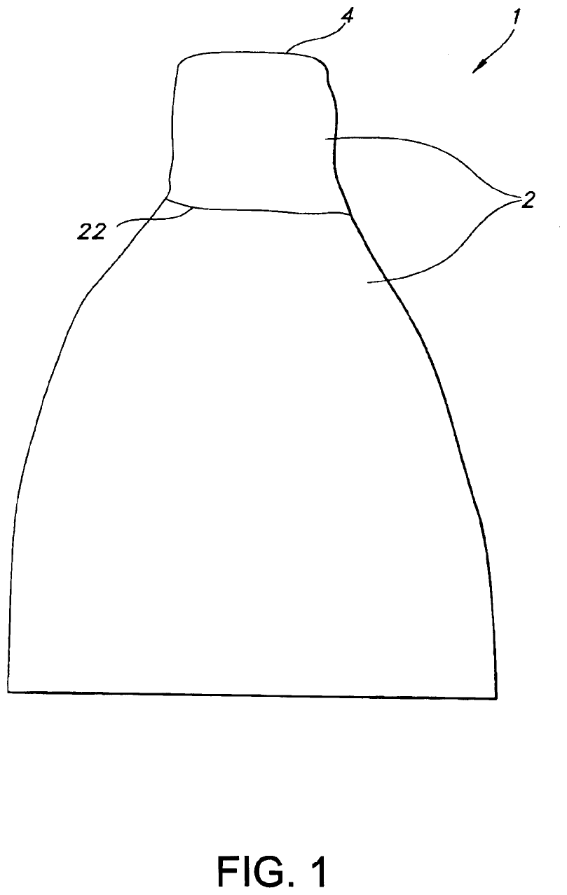

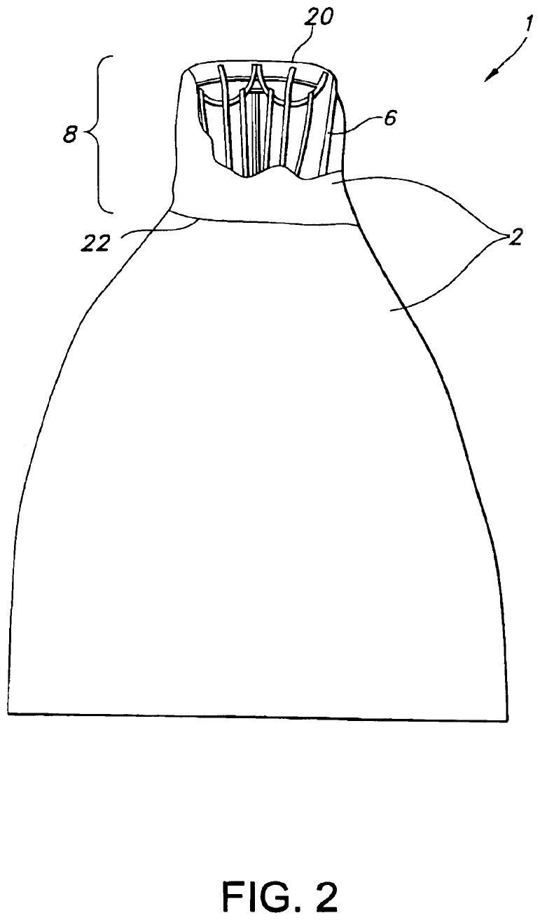

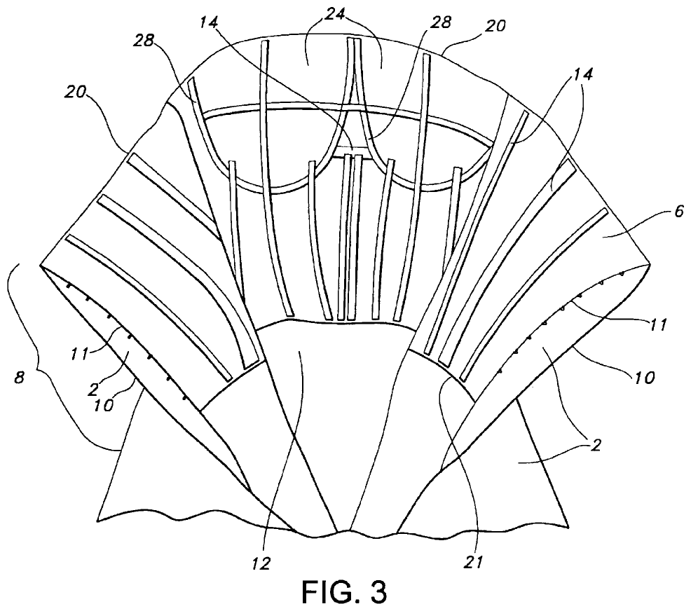

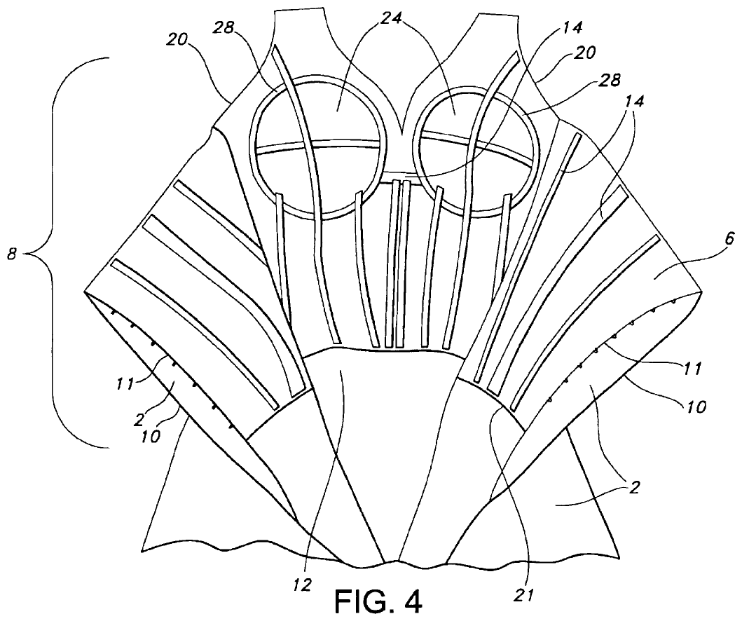

Referring now to the FIGS. 1-2, the composite garment is made of an outer layer of fabric 2 and an inner liner of fabric 6. In the preferred embodiment, the outer layer of fabric has a top edge 4 and a fastenable opening 10 (shown in FIGS. 3-4). The outer layer of fabric 2 is preferably made of satin, silk, or polyester blends, but any material or combination of materials may be used as desired by one skilled in the art. Outer layer of fabric 2 may comprise lining. Outer layer of fabric 2 may be any size as desired by one skilled in the art. Outer layer of fabric 2, as shown in FIGS. 1 and 2, has a natural waistline 22, but any other waistline may be used as desired by one skilled in the art. Also, as shown in FIGS. 1 and 2, outer layer of fabric 2 has a strapless neckline, but any other neckline may be used as desired by one skilled in the art. For example, in one embodiment, the top edge 4 of outer layer 2 forms a strapless neckline (see FIGS. 1-2). In another embodiment, top edge 4 of outer layer 2 forms a halter neckline (see FIG. 4). In a preferred embodiment, fastenable opening 10 (shown in FIG. 3) is preferably a zipper, but any other fastenable opening may be used as desired by one skilled in the art.

Referring again to FIGS. 1-4, the inner liner of fabric 6 is made of anti-wicking, scent-controlled, anti-microbial fabric described herein. In one embodiment, inner liner 6 comprises a bodice support 8 and a slip 12 (best seen in FIGS. 3 and 4). The bodice support 8 has a top edge 20 and a bottom edge 21. The top edge 20 of bodice support 8 is attached to the top edge 4 of the outer layer 2. In a preferred embodiment, two darts are placed in the bodice support 8, but more or less darts may be used as desired by one skilled in the art. The length of bodice support 8 is dependent on the style and size of dress 2 chosen by the wearer. The length of bodice support 8 is the distance from the top edge 20 to the bottom edge 21. In one embodiment, the bottom edge 21 of bodice support 8 is at the natural waistline 22. In another embodiment, the bottom edge 21 of bodice support 8 is extended to follow a dropped waistline (not shown) of dress 2. The dropped waistline is preferably extended one to four inches below the natural waistline 22, but any other length extension may be used as desired by one skilled in the art. The top edge 20 of bodice support 8 is made to align with the neckline and back of outer layer 2. The width of bodice support 8 is dependent on the size of outer layer 2 desired by the wearer. Bodice support 8 is dependent on and consistent with the size and style of the outer layer of fabric 2, including the waistline, neckline, and back of outer layer 2.

Referring now to FIGS. 3-4, the bodice support 8 has a plurality of stays 14 extending from substantially the top edge 20 of bodice support 8 to the bottom edge 21 of bodice support 8. In one embodiment, stays 14 are plastic. In a second embodiment, stays 14 are metal. Metal stays 14 are preferably used with larger size dresses to strengthen the support to the abdomen, midriff, and bust provided by the bodice support 8 to the wearer. Stays 14 may be made of any other material as desired by one skilled in the art. Stays 14 may be curved. Stays 14 are preferably one half centimeter to one centimeter in width, but stays 14 of other widths may be used as desired by one skilled in the art. The length of stays 14, the number of stays 14 used in bodice support 8, and the placement of stays 14 within bodice support 8 are dependent on the style and size of bodice support 8, which is dependent on the size and style of outer layer 2. The length of stays 14 is dependent on and consistent with the length of bodice support 8. In one embodiment, the back of outer layer 2 and bodice support 8 is low and therefore, stays 14 located in the back of bodice 8 are shorter in length. Stays 14 can be sewn down the middle to keep the stays 14 narrow.

Stays 14 are placed within close proximity to each other. The placement of stays 14 is dependent on the style and size of the outer layer 2. The larger the size of outer layer 2, the greater the number of stays 14 used in bodice support 8. The less material used in the style of the bodice support 8 (such as if the bodice support 8 were backless), the greater the number of stays 14 used to provide support to the wearer. Stays 14 are placed within zero centimeters from each other, or side by side, to three and one-half centimeters from each other, but stays 14 may be placed up to approximately seven and one-half centimeters apart as desired by one skilled in the art. In the preferred embodiment, two stays 14 are placed vertically side by side in the center front of the bodice support 8 to support bust cups 24. The number of stays 14 and the placement of stays 14 in bodice support 8 vary as the size and style of outer layer 2 vary to provide support to the wearer. In one embodiment, outer layer 2 is backless and therefore, bodice support 8 has more stays 14 in the front of bodice support 8 and stays 14 are spatially placed as needed to provide support to the wearer. Stays 14 are placed within bodice support 8. Stays 14 are spatially placed throughout bodice support 8 to support and enhance the midriff, abdomen, and bust of the wearer. Bodice support 8 has at least eight stays 14, but more stays 14 may be used as desired by one skilled in the art. For example, bodice support 8 is made to accommodate a ladies dress size fourteen and has eighteen stays 14 within bodice support 8.

Referring again to FIGS. 3-4, the bodice support 8 has a fastenable opening 11 coexistent with the fastenable opening 10 of outer layer of fabric 2. In the preferred embodiment, fastenable opening 11 of bodice support 8 is made of hooks and eyes, but other materials may be used as desired by one skilled in the art.

Referring now to FIGS. 3-4 and 5-6, bodice support 8 has bust cups 24 configured to receive and support the breasts of the wearer. Bust cups 24 are made of polyester lining and interfacing, but any other material or combination of materials may be used as desired by one skilled in the art. Bust cups 24 may contain different amounts and types of padding material as desired by one skilled in the art to provide more or less support and enhancement to the breasts. Each bust cup 24 has a perimeter 28 (see FIGS. 5 and 6). Perimeter 28 is a rigid arcuate brace. In one embodiment, one horizontal stay 14 traverses bust cups 24 and runs continuously across bust cups 24. In another embodiment, one horizontal stay 14 traverses the apex of each bust cup 24 and does not run continuously across bust cups 24. One curved vertical stay 14 traverses the apex of each bust cup 24 and runs continuously into the midriff and abdomen areas of the bodice support 8. In a preferred embodiment, vertical stay 14 which traverses the apex of each bust cup 24 is sewn down the middle to make stay 14 narrow. One horizontal stay 14 connects the inner perimeters 28 of bust cups 24. Perimeter 28 of bust cups 24 is preferably made of metal underwire, but other materials such as plastic may be used as desired by one skilled in the art. In one embodiment, perimeter 28 encircles each entire bust cup 24 (best seen in FIGS. 4 and 6). In another embodiment, perimeter 28 encircles part of each bust cup 24 (best seen in FIGS. 3 and 5). The top edge 20 of bodice support 8 determines the extent to which perimeter 28 encircles each bust cup 24.

Referring again to FIGS. 3-4, slip 12 of inner liner 6 may be attached to the bottom edge 21 of bodice support 8. Slip 12 is not attached to dress 2. Slip 12 is preferably made of polyester lining, but other materials, such as silk, or combination of materials may be used as desired by one skilled in the art.

Top edge 20 of bodice support 8 is attached to the top edge 4 of outer layer of fabric 2. Bodice support 8 is approximately one-half inch smaller than the bodice of outer layer 2. Top edge 4 of outer layer 2 and top edge 20 of bodice support 8 have no seam allowance for alteration. In a preferred embodiment, a top stitch is sewn to top edges 4 and 20 to ensure the placement of outer layer 2. Outer layer of fabric 2 has a seam allowance that may be altered to accommodate the wearer of outer layer 2. The seam allowance is located on each side and center back of the bodice of outer layer 2. The seam allowance in outer layer 2 is approximately three to five inches. Inner liner 6 has a seam allowance that may be altered to accommodate the wearer. The seam allowance in inner liner 6 is approximately three to four inches and is located on the side and center back of bodice support 8. In a preferred embodiment, the seam allowance in inner liner 6 corresponds to any alteration made to the seam allowance in outer layer of fabric 2. At least one stay 14 is placed on the reverse side of each side seam allowance in bodice support 8 (not shown).

Referring now to FIGS. 1-4, the present invention discloses a method to manufacture a composite garment 1 comprising: (a) obtaining an outer layer of fabric 2 which has a top edge 4, a fastenable opening 10, and a seam allowance (not shown); (b) obtaining an inner liner 6 comprising anti-wicking, scent-controlled, anti-microbial fabric, wherein the inner layer 6 may comprise a bodice support 8 and a slip 12, bodice support 8 has a top edge 20 and a bottom edge 21, bodice support 8 has a fastenable opening 11 coexistent with the fastenable opening 10 of outer layer of fabric 2, bodice support 8 has a plurality of stays 14 which extend from the top edge 20 of bodice support 8 to the bottom edge 21 of bodice support 8 and which are placed in close proximity to each other, bodice support 8 has a seam allowance (not shown), slip 12 is attached to the bottom edge 21 of bodice support 8; (c) altering the scam allowance (not shown) in dress 2 to accommodate the wearer of dress 2; (d) altering the seam allowance (not shown) in bodice support 8 of inner liner 6 to accommodate the wearer of inner liner 6; (e) attaching the top edge 4 of outer layer of fabric 2 to the top edge 20 of bodice support 8.

Referring now to FIGS. 1-4, the seam allowance (not shown) in outer layer of fabric 2 is approximately three to five inches, but said seam allowance may be more than five inches or less than three inches as desired by one skilled in the art. The seam allowance of dress 2 is located on the sides of the bodice of dress 2 and on the center back beside the fastenable opening 10 of outer layer 2.

I claim:

1. A composite garment, the garment comprising:
an inner layer; and
an outer layer;
wherein said inner layer and said outer layer are attached; and
wherein said inner layer is made of inner layer fabric which has been treated with an anti-wicking finish.

2. The composite garment of claim 1, wherein said inner layer fabric is treated with an anti-microbial control.

3. The composite garment of claim 2, wherein said inner layer fabric is treated with a scent control.

4. The composite garment of claim 3, wherein said scent control treatment is applied by a process comprising:
placing a scent control treatment in a bath;
running a roll of fabric comprising said inner layer fabric through said bath; and
running said roll of fabric through a dryer.

5. The composite garment of claim 3, wherein said inner layer fabric comprises 85% nylon and 15% spandex.

6. The composite garment of claim 5, wherein said inner layer fabric comprises FDN70d/72f+40d Spandex.

7. The composite garment of claim 3,
wherein said inner layer fabric comprises 100% polyester; and
wherein said yarn type and yarn size is FDP75d/72f×FDP90d/96f.

8. The composite garment of claim 3, wherein said inner layer further comprises a bodice support.

9. The composite garment of claim 8, wherein said garment is a dress.

10. The composite garment of claim 3, wherein said garment is a suit.

11. A method of manufacturing a composite garment, the method comprising:
obtaining an outer layer of fabric having a top edge, a fastenable opening, and a seam allowance;
obtaining an inner liner of fabric comprising a top edge and a bottom edge, a fastenable opening coexistent with said fastenable opening of said composite garment, wherein the inner liner of fabric comprises moisture-wicking, scent-controlled, anti-microbial fabric, wherein the inner liner comprises a bodice support having a plurality of stays which extend from substantially the top edge of the bodice support to the bottom edge of the bodice support and which are placed in close proximity to each other, and a seam allowance, wherein a slip is attached to the bottom edge of the bodice support;
altering the seam allowance in the outer layer of fabric to accommodate the wearer of the dress;
altering the seam allowance of the inner liner of fabric to accommodate the wearer of the liner; and
attaching the top edge of the outer layer of fabric to the top edge of the inner liner of fabric.

12. The method of claim 11, wherein said fastenable opening is a zipper.

13. The method of claim 11, wherein said garment is a dress.

14. The method of claim 11, wherein said garment is a suit.

15. The method of claim 11, wherein said scent control treatment is applied by a process comprising:
placing a scent control treatment in a bath;
running a roll of fabric comprising said inner layer fabric through said bath; and
running said roll of fabric through a dryer.

16. The method of claim 11, wherein the seam allowance is approximately 3-4 inches.
